(19) United States
(12) Patent Application Publication
(10) Pub. No.: US 2004/0133549 A1
(43) Pub. Date: Jul. 8, 2004

(54) System and method for organizing and disseminating data in a management information system

(76) Inventors: Michael J. Stevens, Rosemont, IL (US); Bruce Montgomery, Naperville, IL (US); Bruce Vosburgh, Rosemont, IL (US)

Correspondence Address: PHILIPS INTELLECTUAL PROPERTY & STANDARDS, P.O. BOX 3001, BRIARCLIFF MANOR, NY, 10510, US

(21) Appl. No.: 10/714,739

(22) Filed: Nov. 17, 2003

Related U.S. Application Data
(60) Provisional application No. 60/434,578, filed on Dec. 19, 2002.

(51) Int. Cl. G06F 7/00

(52) U.S. Cl. 707/1

(57) ABSTRACT

The present invention discloses a system and method for improving the organization and dissemination of information in a management information system (MIS). Improved security, organization and delivery of data is achieved in an MIS through the creation of a number of novel databases and an associated method of utilization whereby outside suppliers are provided with timely and secure access to drawing information stored at the MIS. In accordance with the novel data organization and dissemination methods of the invention, the MIS is assured that vendors will have a capability to only view drawings and related information which pertain to the particular vendor thereby preventing the vendor from viewing and/or accessing other vendor's information.

### REFERENCE TO RELATED APPLICATION

This application claims priority from Provisional Application Serial No. 60/434,578, filed Dec. 19, 2002.

### BACKGROUND OF THE INVENTION

1. Field of the Invention

The invention generally relates to management information systems (MIS) and more particularly to a system and method for providing improved data security, organization and delivery in an MIS.

2. Description of the Related Art

Management information systems (MIS), such as the well known and widely deployed SAP management information system from SAP AG^{T} of Walldorf, Germany, are structured on the concept of workgroups. Broadly defined, in a workgroup, files and data are shared by means of a network. Accordingly, the workgroup principle provides numerous advantages for exchanging and facilitating the flow of information amongst users. However, there are associated drawbacks. As one example, the concept of workgroups extends to outside suppliers. This is undesirable in that the management entity controlling the operations of the MIS do not wish for the material supplier to have access to the workgroup data without restriction. Ideally, the outside supplier should only be provided with access to drawings (i.e., component and/or material drawings) and related information for which the outside supplier has been approved and be otherwise restricted from viewing drawings pertaining to the whole product (i.e., finished product drawings, intermediate assembly drawings).

Therefore, a need exists for supplying outside suppliers with timely information for only drawings and related information for which the supplier has been approved.

### SUMMARY OF THE INVENTION

The present invention is directed to a system and method for improving the organization and dissemination of information in a management information system (MIS).

According to an aspect of the invention, a method for improving the organization and dissemination of information in a management information system (MIS) includes the steps of: identifying at the MIS at least one outside vendor who supplies at least one material included in a notification of drawing change issued from the MIS; (b) issuing said notification of drawing change from the MIS to the at least one outside vendor identified at the identifying step; accessing an MIS website by the at least one outside vendor responsive to the issued notification; submitting a database search query by the at least one outside vendor at said MIS website including search criteria for viewing drawings prepared by and stored at the MIS; retrieving a list of drawings at the MIS satisfying said submitted database search query; filtering said retrieved list of drawings at said MIS to exclude drawings unrelated to the at least one outside vendor; and displaying the filtered drawing list to the at least one outside vendor.

According to another aspect of the invention, a system for improving the organization and dissemination of information in a management information system (MIS), the system comprising: means for identifying at the MIS at least one outside vendor who supplies at least one material included in a notification of drawing change issued from the MIS; means for issuing the notification of drawing change from the MIS to the at least one outside vendor identified at the step (a); means for accessing an MIS website by the at least one outside vendor responsive to the issued notification; means for submitting a database search query by the at least one outside vendor at the MIS website including search criteria for viewing drawings prepared by and stored at the MIS; means for retrieving a list of drawings at the MIS satisfying the submitted database search query; means for filtering the retrieved list of drawings at the MIS to exclude drawings unrelated to the at least one outside vendor; and means for displaying the filtered drawing list to the at least one outside vendor.

Advantageously, the system and method of the invention provides conveniences to the outside suppliers by first being informed in a timely manner of engineering drawing changes and also for being provided with an access mechanism for responding to drawing change notifications by conveniently accessing the MIS website over an electronic network to view the pertinent drawings and associated information. The MIS system is provided with enhanced security by allowing suppliers access to only those drawings and associated drawing information which are associated with the supplier.

The foregoing features of the present invention will become more readily apparent and may be understood by referring to the following detailed description of an illustrative embodiment of the present invention, taken in conjunction with the accompanying drawings, where:

### BRIEF DESCRIPTION OF THE DRAWINGS

FIG. 1 is a block diagram showing the arrangement of one embodiment of an SAP management information system according to the present invention;

FIG. 2 is a figure illustrating the novel databases of the invention;

FIG. 3 is a flowchart which explains, at a top level, the processes involved in organizing and disseminating information in the SAP management information system;

FIG. 4 is a flowchart which explains the steps performed by the data population process step of FIG. 2;

FIG. 4 is a flowchart which explains the steps performed by the drawing change notification process step of FIG. 2;

FIG. 5 is a flowchart which explains the steps performed by the access to drawing change process step of FIG. 2;

FIG. 6 illustrates an exemplary engineering drawing change (ECO) emailed from the SAP MIS 10 to a qualified primary vendor;

FIG. 7 is a flowchart which explains the steps performed by the access to drawing change process, described at step 3500 of the flowchart of FIG. 3;

FIG. 8 is a screen view illustrating an example of a ‘home’ Web page received by the end-user's browser upon typing in the URL associated with the SAP website;

FIG. 9 is a screen view illustrating a Web page returned to the end-user's Web browser upon selection of the “Online Transactions” hyperlink of web page of FIG. 8;

FIG. 10 is a screen view illustrating the Web page displayed by the end-user's Web browser to the vendor upon selection of the “Engineering Drawings” hyperlink from the Web page of FIG. 9;

FIG. 11 is a screen view illustrating a Web page returned to the end-user's Web browser upon selection of the “Engineering Drawings” hyperlink from the Web page of FIG. 10;

FIG. 12 is a flowchart which explains step 715 of the flowchart of FIG. 7;

FIG. 13 is an exemplary unfiltered drawing list returned in response to a query submitted to the SAP DMS portion of the MIS;

FIG. 14 is the drawing list of FIG. 13 filtered to exclude all drawings which do not pertain to the vendor/manufacturer making the query;

FIG. 15 is a screen view illustrating a web page returned to the end-user's web browser upon the selection of the QML (Qualified Manufacturer's List) Report hyperlink in FIG. 9;

FIG. 16 is a screen view illustrating a web page returned to the end-user's web browser of the data returned for a QML query;

FIG. 17 is a screen view of a text entry screen for entering search criteria to inquire about changes which have occurred to a material supplied by an outside vendor; and

FIG. 18 is a screen view illustrating a Web page returned to the vendor's Web browser in response to the formulated search query provided at FIG. 17.

### DESCRIPTION OF THE INVENTION

In the following description, for purposes of explanation rather than limitation, specific details are set forth such as the particular architecture, interfaces, techniques, etc., in order to provide a thorough understanding of the present invention. For purposes of simplicity and clarity, detailed descriptions of well-known devices, circuits, and methods are omitted so as not to obscure the description of the present invention with unnecessary detail.

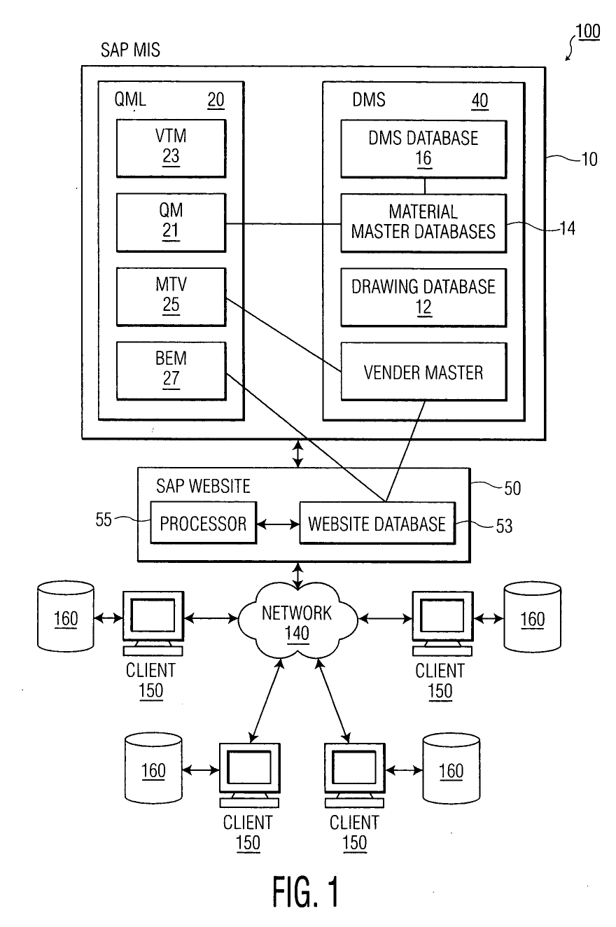

FIG. 1 shows a block diagram of a network environment 100, in which the features of the invention may be implemented. In particular, system 100 includes an SAP management information system (MIS) 10 comprised of a QM sub-system 20 in communication with a document management sub-system (DMS) 40. The SAP MIS 10 performs innumerable functions related to the organization and dissemination of management and engineering related information. One of the many functions performed by the SAP MIS 10 is the development and maintenance of engineering drawings. To satisfy this function, the SAP MIS 10 must perform at least the following sub-functions: (1) manually locate and qualify manufacturers and suppliers (vendors) of materials used in the engineering drawings, (2) update drawings whenever it is required, (3) store drawing and drawing change information in a manner that permits it to be selectively disseminated to those qualified outside suppliers/manufacturers on a need to know basis, and (4) inform those qualified outside suppliers/manufacturers of those drawing updates that may impact them as suppliers/manufacturers. The present invention is directed primarily but not exclusively to steps (3) and (4) above.

The QML sub-system 20 of the SAP MIS 10 is shown to include four databases created in accordance with the principles of the invention which allow the MIS to make engineering drawings and related information selectively available to suppliers/manufacturers strictly on a need to know basis. The databases contain data specific to those manufacturers and vendors who have been qualified to supply material to Advance^{T}, a managing entity of the SAP MIS 10. The four databases shown include a qualified manufacturer's (QM) database 21, a vendor-to-manufacturer's (VTM) database 23, a manufacturer's-to-vendors (MTV) database 25 and a block-email (BEM) database 27.

With continued reference to FIG. 1, network 140 connects the SAP MIS 10 and client nodes 150 (e.g., vendors and manufacturers), via the SAP website 50, which may be local or remote from the SAP MIS 10. The SAP website 50 includes a website database 53 and processor 55 for controlling communication functions between the SAP MIS 10 and the client nodes 150. Network 140 may include one or more communication networks, including the Internet or any other similar network that supports Web-based processing. Client nodes 150 may connect to network 140 through any suitable wired or wireless supported connection.

Client nodes 150 may include a desktop computer, workstation, laptop, personal digital assistant or any other similar client side system known in the art. Client nodes 150 are equipped with browser software such as Netscape Navigator, Microsoft Internet Explorer, or any other known browser software. A client-side data store 160 may also be provided for storing downloaded engineering drawings, ECO notifications, and other information.

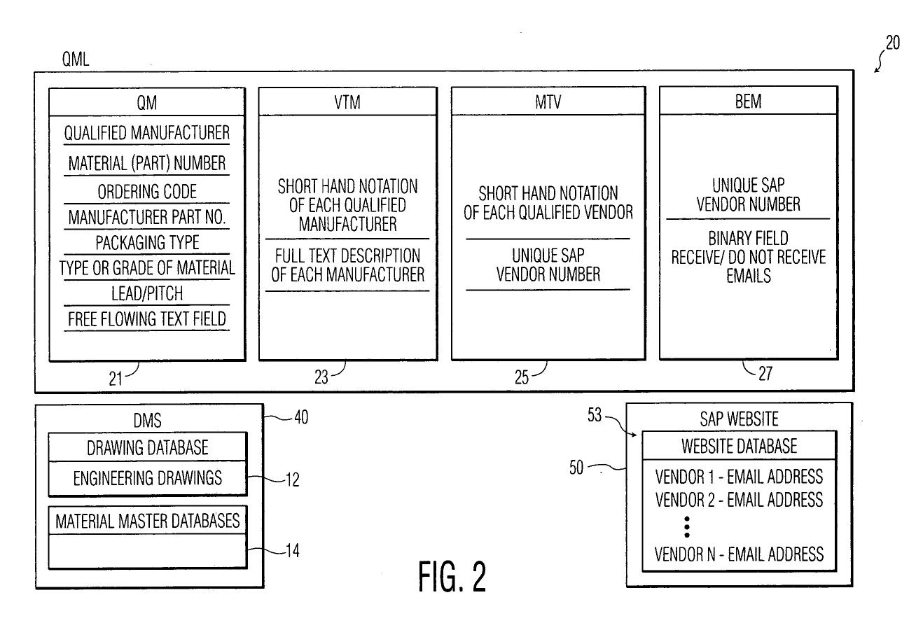

FIG. 2 is a diagram that defines the fields which make up the respective databases shown in FIG. 1. Referring first to the QM database 21 which stores information pertaining to qualified manufacturers and includes at least a qualified manufacturer field, a material (part no.) field, an ordering code field, a manufacturer part number field, a packaging type field, a type or grade of material field, a lead/pitch field and a free flowing text field. The purpose and use of the QM database 21 will be described below.

Referring next to the VTM database 23 which includes at least a first field which defines a short-hand notation for each qualified manufacturer from the QM database 21 and a second field which is a full-text description of the manufacturer. The VTM database 23 is used as a safeguard to prevent the occurrence of a user entering the same manufacturer name into the QM database 21 multiple times under slightly different spellings. In operation, when a user types in a manufacturer name to retrieve data from the QM database 21, the name is first checked against the entry in the VTM database 23 to insure that the user is typing in a valid manufacturer name. For example, assume that Panasonic Corporation of North America has been qualified for the first time. A short-hand notation is generated for the name “Panasonic Corporation of North America”, such as “PAN-NA” and entered into the VTM database 23. Thereafter, whenever a user attempts to access the QM database 21 for the Panasonic Corporation, the typed in name will be checked against the “PAN-NA” label entered in the VTM database 23.

Referring next to the MTV database 25 which stores information defining which vendors supply material(s) for a qualified manufacturer. The MTV database 25 includes at least a first field which is a short hand notation for a qualified manufacturer (e.g., PAN-NA), and a second field which is a unique SAP vendor number assigned by the SAP MIS 10 to the vendor. It is noted that oftentimes a manufacturer can be its own supplier (vendor) in which case the second field will be the SAP number for the manufacturer acting in the capacity of a vendor.

Referring now to the BEM database 27 of FIG. 2 which stores information regarding which vendors will and will not receive email notifications of engineering drawing changes generated by the SAP MIS 10 in the event the drawing change includes a change of material supplied by a vendor. The BEM database 27 includes at least a first field which is the vendor's unique SAP number assigned by the SAP MIS 10 and a second field which is essentially a binary field (i.e., on/off) defining whether the vendor should or should not receive email notifications of engineering drawing changes (ECO's).

FIG. 2 also shows the drawing database 12 and material master database 14 included as elements of the SAP DMS 40 sub-system. As engineering drawings are created in the SAP MIS 10 they are stored in the drawing database. Whenever a material required to be purchased from an outside vendor is included in a newly created engineering drawing, the material master databases 14 are updated accordingly and associated bill of materials are created.

Also shown in FIG. 2 is the SAP website database 53 for storing email addresses for vendors who should receive ECO notifications via email from Advance^{T}, as will be described further below.

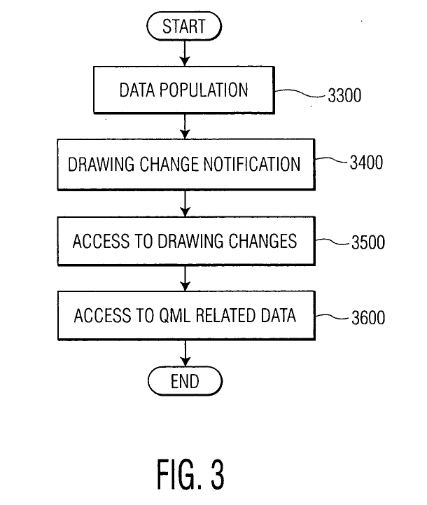

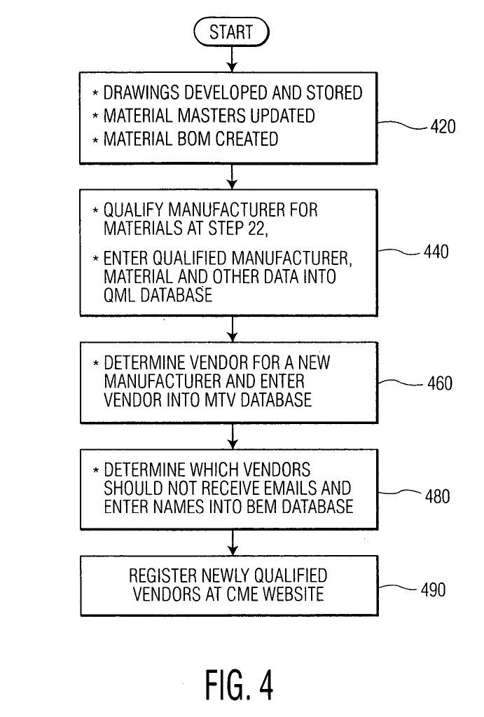

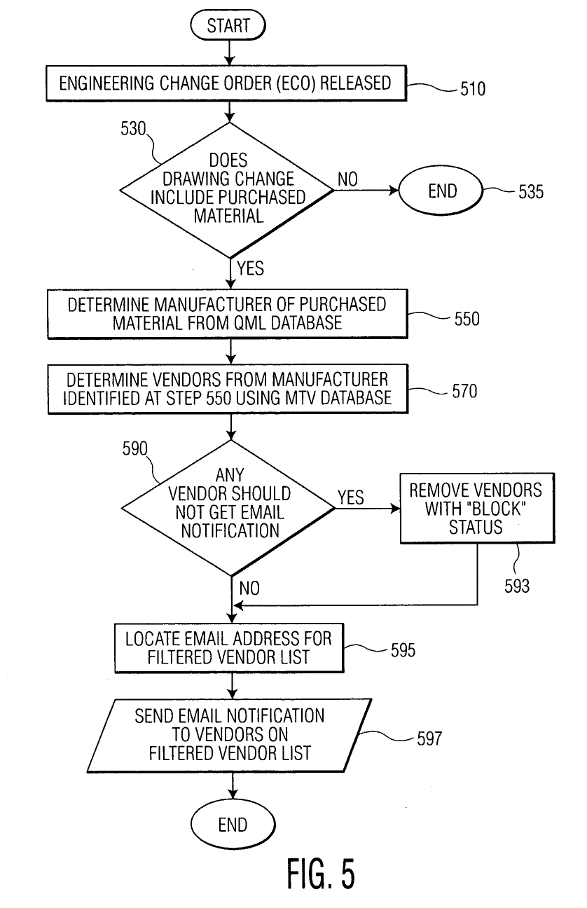

FIG. 3 is a top-level flowchart of the method embodiment of the manufacturer and vendor information system of the present invention. FIG. 3 includes four general processes performed in accordance with the method of the invention. A first process, “Data Population” 3300, is related to how the databases created in accordance with the principles of the invention are initially populated with data, as will be described below with respect to the flowchart of FIG. 4. The second process, “Drawing Change Notification” 3400, is related to how vendors and/or manufacturers are notified in the event of an engineering drawing change affecting one or more purchased materials, as will be described below with respect to the flowchart of FIG. 5. The third process, “Access To Drawing Changes” 3500 is related to how a vendor and/or manufacturer may access the SAP MIS 10 upon being notified of a material change in an engineering drawing being supplied by the vendor. The fourth process, “Access TO QML Related Data” 3600 is related to vendor specifications as interpreted by the SAP MIS. It is a conventional practice of the Advance Transformer (ATC) to receive specifications from the various vendors and interpret those specifications for internal purposes. The ATC interpreted specifications are stored as part of the SAP database. In the event a dispute arises between ATC and an outside vendor concerning a supplied material, both the vendor's specification and ATC's interpreted vendor specification are consulted to resolve the dispute. Further, the SAP interpreted vendor specifications are also used by SAP quality control inspectors when materials are received from vendors.

Data Population Process

Referring now to FIG. 4, which is a more detailed flowchart of the “data population” process described at step 3300 of FIG. 3.

At step 420, engineering drawings are created in the SAP MIS 10 and stored in an engineering drawing database 12 as part of the DMS system 40. Whenever a material required to be purchased from an outside vendor is included in a newly created engineering drawing, the material master databases 14 are updated accordingly and associated bill of materials are created.

At step 440, a component engineering (CE) group affiliated with Advance^{T}, the management entity controlling the SAP MIS 10, qualifies a manufacturer for those outside purchased materials identified in the newly created drawings. The step of qualifying a manufacturer involves finding a manufacturer who is able to supply a material(s) that substantially meets an internally generated CE specification for that material. Once a manufacturer is qualified, the manufacturer and material specifications are entered into the QM database 21. It is noted that if a qualified manufacturer is new to the SAP MIS 10, (i.e., not previously listed in the QM database 21) the manufacturer must first be added to the Valid Manufacturers (VTM) database 23.

At step 460, It is the responsibility of CE to notify the purchasing department of newly qualified manufacturers. Upon being notified, purchasing then proceeds to qualify one or more vendors capable of supplying the material made by the newly qualified manufacturer. Once a vendor is found, an SAP vendor number is then assigned to the newly qualified vendor to be entered into the manufacturer-to-vendor (MTV) database 25.

At step 480, certain outside vendors are excluded from receiving engineering change orders (ECO's) via email from the SAP MIS 10. Periodically, the Advance^{T} purchasing group reviews its qualified vendors and determines which vendors should not receive engineering change order (ECO) notifications. Typically, it is decided that only one or two vendors for a given material are qualified to receive the ECO's as representing reliable supply sources, referred to herein as ‘primary’ vendors. Those other qualified “non-primary” vendors which have been excluded from receiving email notifications are only called upon as a material supply source in the event of an unexpected increase in demand. The distinction between “primary” vendors and “non-primary” vendors is recorded in the BEM database 27 in a binary field having allowable values “receive” and “block”, where a “block” status indicates that that the vendor should not receive email notifications of ECO's from the SAP MIS 10.

At step 490, a newly qualified vendor registers for access to the SAP website 50. To register, the vendor supplies his business name. In response, the SAP MIS 10 looks up the business name supplied by the vendor to look up a previously assigned vendor SAP number. Once found, the website 50 supplies the vendor with a sign-on user name, password and a six-digit SAP vendor number which is initially assigned when a vendor is first approved by the purchasing department for future access to the SAP website 50. The vender logs onto the website using his username and password. The SAP MIS uses the vendor number to identify the user in the SAP that system. The SAP vendor number is invisible to the user.

Drawing Change Notification Process

Referring next to FIG. 5, which is a more detailed flowchart of the “drawing change notification” process at step 3400 of FIG. 3.

At step 510, whenever a change to an engineering drawing is completed, at some point the engineering change order (ECO) is given a “released” status.

At step 530, an SAP routine within the SAP MIS 10 reviews the released ECO and determines whether the ECO affects at least one drawing, if so, the SAP routine then looks to determine if the at least one drawing is linked to a purchased material. Otherwise, the process terminates at step 535.

At step 550, the purchased material identified at step 530 is used as an index into the QM database 21 to lookup the manufacturer of the identified material. In the event the SAP routine does not find a manufacturer in the QM database 21, a notification is generated by the SAP routine and sent to the Advance^{T} CE group to enter the manufacturer' name to the QM database 21. This situation may occur through inadvertence where a manufacturer has been previously qualified by Advance^{T} but the step of entering the manufacturer into the QM database 21 was overlooked.

At step 570, the manufacturer identified at step 550 is now used as an index into the MTV database 23 to lookup the vendors which are associated with the manufacturer identified at step 550. A vendor list is created from the lookup procedure. If no vendors are identified from the MTV database 23, a workflow notification is issued by the SAP routine to the Advance^{T} purchasing department to create such a relationship in the MTV database 23. This situation may occur through inadvertence whenever purchasing fails to make the proper database entries in the MTV database 23 at the point in time where a vendor is first qualified by Advance^{T}.

At step 590, prior to sending notifications to the vendors identified at step 570, a check is made in the BEM database 27 to determine if any of the identifiers vendors should not receive ECO notifications. As discussed above, those vendors having their ECO notification status set to “block” should not receive email notifications of ECO's.

At step 593, those vendors who were identified at step 590 as having their ECO notification status set to “block” in the BEM database 27 are then filtered (deleted) from the vendor list constructed at step 570.

At step 595, the filtered vendor list, now including only vendors having an ECO notification status of “receive”, is then transmitted to the SAP website processor 55 to perform a lookup to determine the email addresses for each qualified primary vendor in the filtered list. The vendor email addresses are stored in a website database 53 associated with the website processor 55.

At step 597, an email is issued from the SAP MIS 10 to all of the “primary” vendors in the filtered list so as to notify those vendors that a material affecting that vendor is being changed or modified in accordance with a released ECO.

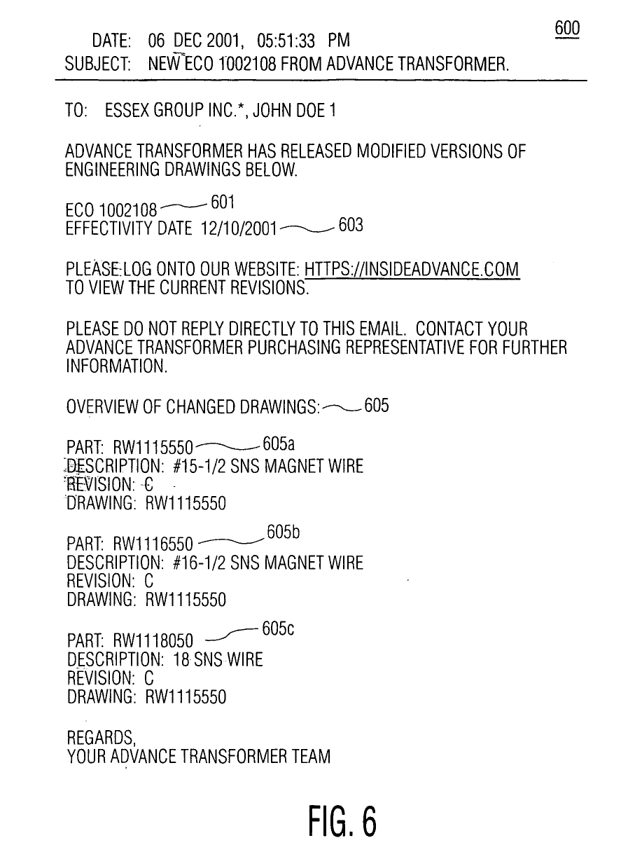

FIG. 6 illustrates an exemplary notification of drawing change 600 (here in the form of an ECO) emailed from the SAP MIS 10 to a qualified primary vendor. The ECO includes a change number 601, the effectivity date 603 for determining when the ECO becomes effective and three engineering changes 605 shown for engineering drawing RW1115550, i.e., 605a, 605b and 605c.

Access to Drawing Change Process

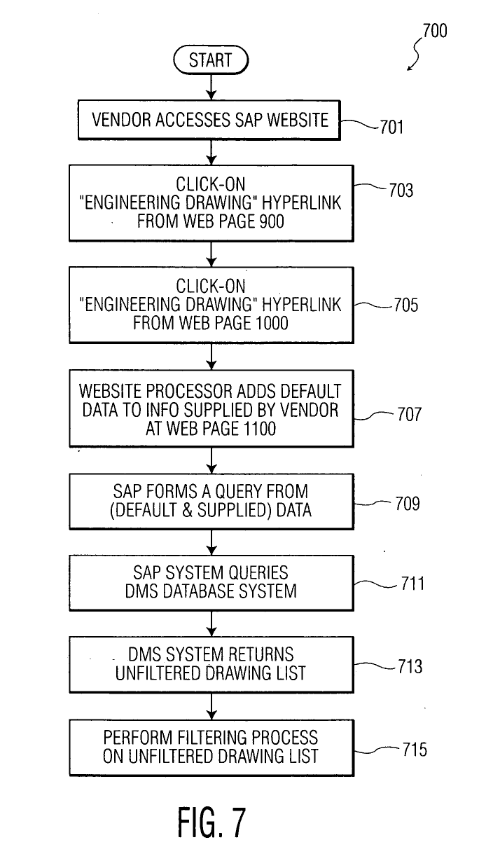

Referring next to FIG. 7, there is shown is a flowchart of the steps performed by the access to drawing change process, described at step 3500 of FIG. 3.

It should be noted that an end-user (e.g., vendor, manufacturer) can access the SAP website 50 at any time, however, it is more typically the case that an end-user will access the SAP website 50 in response to receiving an ECO notification via email.

At step 701, a vendor accesses the SAP website 50 in response to receiving an email, including an ECO notification informing the vendor that a material or component supplied by the vendor has been changed in some manner and requires the vendor's review.

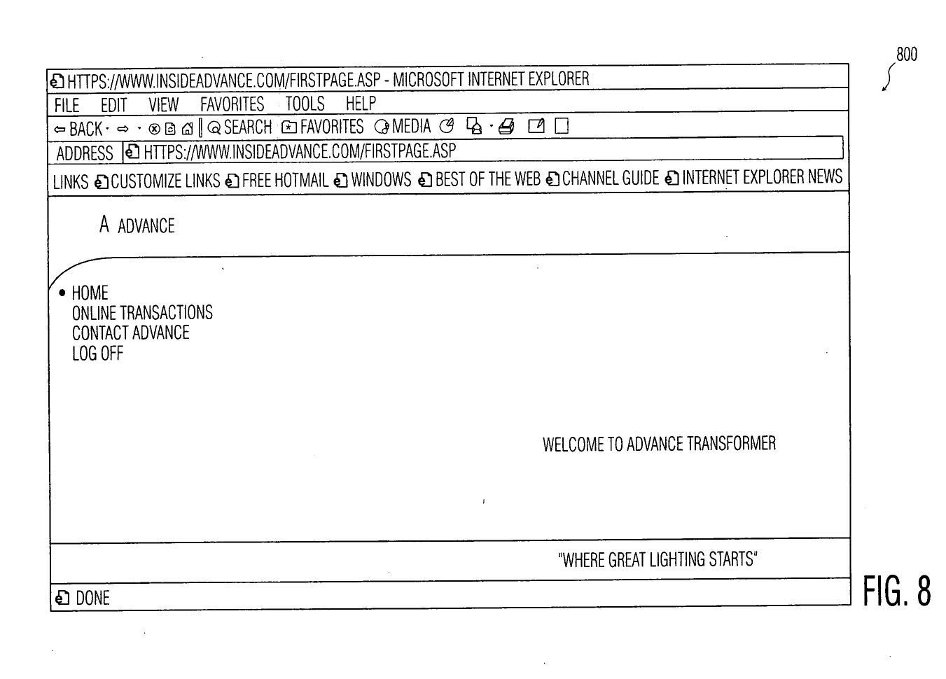

FIG. 8 is a screen view illustrating an example of a ‘home’ Web page 800 received by the vendor's browser upon typing in the URL associated with the SAP website 50. As illustrated, the ‘home’ Web page 800 contains a hyperlink list of options that are available to the vendor upon selection. A first option available to the vendor is “Online Transactions”. This link should be selected by the vendor for learning additional details about the ECO notification received via email from the SAP MIS 10.

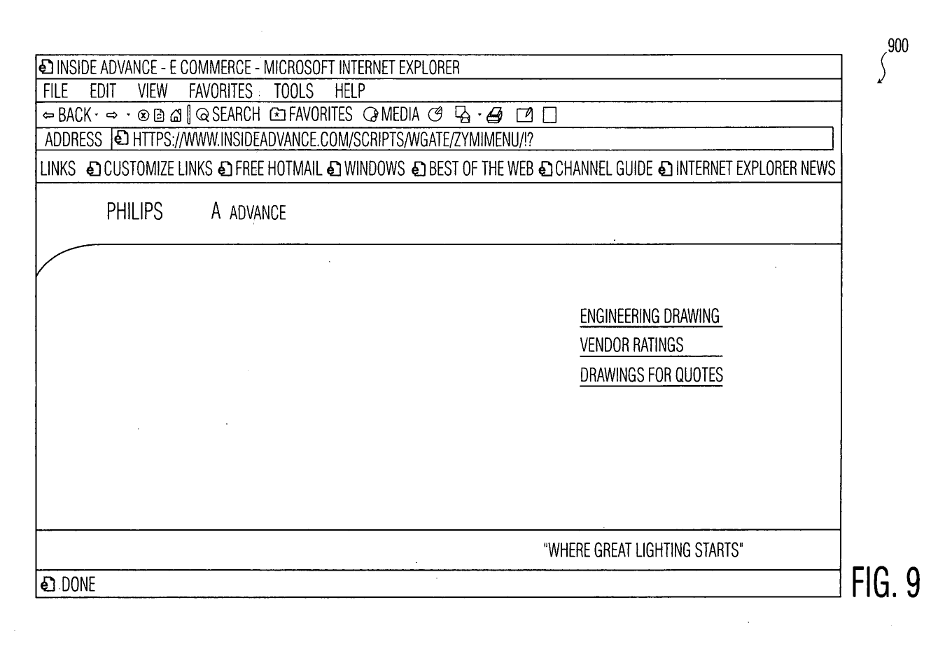

FIG. 9 is a screen view illustrating a Web page 900 returned to the vendor's Web browser upon selection of the “Online Transactions” hyperlink. As illustrated, the Web page 900 includes three hyperlinks, “Engineering Drawings”, “Vendor Review” and “Drawings for Quotes”. For purposes of the instant application, only the “Engineering Drawings” hyperlink is germane to the instant application and will be discussed further.

At step 703, the vendor “clicks-on” the “Engineering drawing” hyperlink from Web page 900.

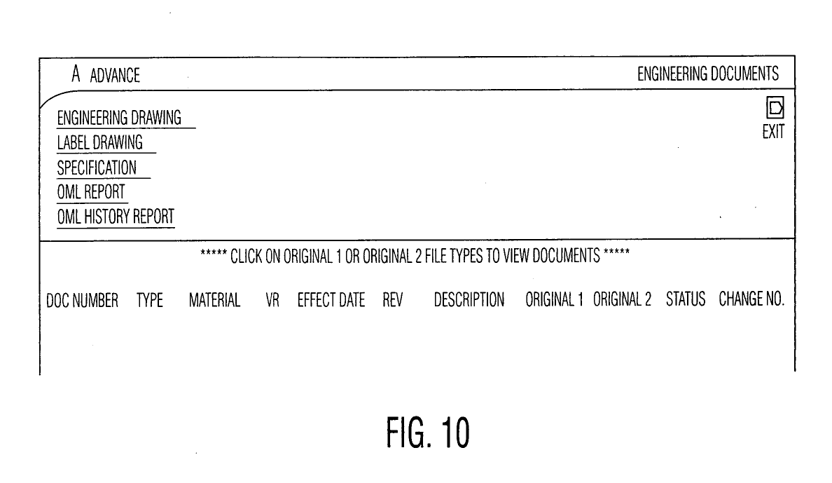

FIG. 10 is a screen view illustrating the Web page 1000 displayed by the end-user's Web browser to the vendor upon selection of the “Engineering Drawings” hyperlink from Web page 900. Web Page 1000 includes five hyperlinks including an “Engineering drawing” hyperlink, a “Label drawing” hyperlink, a “Specification” hyperlink, a “QML Report” hyperlink and a “QML History Report” hyperlink. At this point, the vendor has the option of selecting any one of the five displayed hyperlinks. The “label drawing” hyperlink is related to labeling artwork that is required for placement on the parts and materials which comprise the products built by the SAP MIS 10.

At step 705, the vendor “clicks-on” the “Engineering drawing” hyperlink from Web page 1000 to learn additional details concerning the ECO notification received via email.

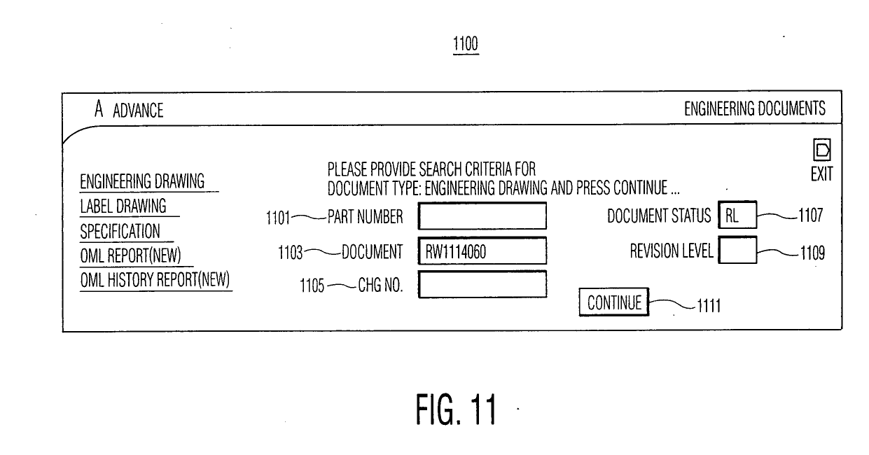

FIG. 11 is a screen view illustrating a Web page 1100 returned to the end-user's Web browser upon selection of the “Engineering Drawings” hyperlink from Web page 1000. Web page 1100 includes a number of text entry boxes 1101,1103,1105,1107 and 1109 for entering search criteria for locating drawings of interest to the vendor (manufacturer may be suitably interchanged). The vendor is provided with the option of not filling in any of the displayed entry boxes, in which case, the vendor will be shown all drawings for which there is at least one identified material assigned to the vendor. The SAP MIS 10 will, by default, return all drawings effective thirty days prior to the current date and into the future. This is to allow the vendor to see what he or she was supplying in the recent past as a means for comparing what the vendor is currently supplying. Entry boxes 1101 through 1109 are intended as an aid to the vendor to filter the request so as to return only those drawings of interest to the vendor.

At step 707, a SAP website processor 55 adds the six-digit vendor number obtained from the registered user table maintained at the website, the effectivity date, and a drawing status of “released” to any information which may have been provided by the vendor at Web page 1100 and forwards all of the information to an SAP routine within the SAP MIS 10. The vendor may, for example, elect to enter search criteria such as the part no. 1101, Document no. 1103 or Change No. 1105.

At step 709, an SAP routine forms an SAP search query from the combination of default data supplied by SAP website 10 and any search criteria that may have been provided by the vendor at Web page 1100 to formulate the SAP search query for locating the requested engineering drawings.

At step 711, using the SAP query formed at step 709, the SAP MIS 10 queries the DMS database system 16 which typically returns a large number of drawings, both vendor related and non-vendor related drawings (referred to herein as the unfiltered drawing list). The unfiltered drawing list satisfies the vendor supplied search criteria at Web page 1100. It is noted that the vendor supplied criteria can be narrow or broad (i.e., vendor leaves all search fields blank). In the case of a broad search criteria, the unfiltered drawing list returned to the vendor will typically include many drawings having no relation to the vendor.

At step 713, the unfiltered drawing list is returned from the DMS database 16 in response to the SAP query at step 711.

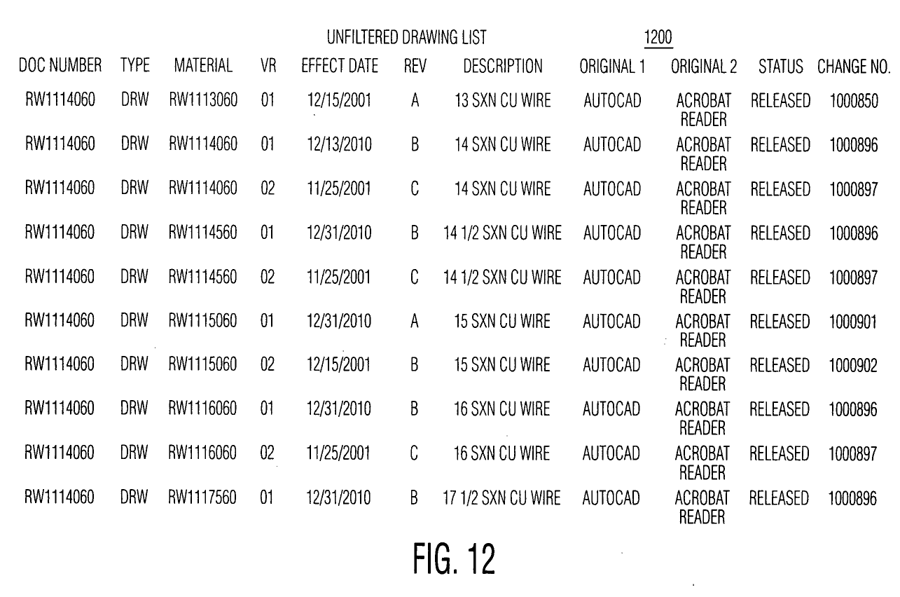

FIG. 12 is an illustration of an exemplary unfiltered drawing list 1200 returned by the SAP DMS 40 in response to the SAP query for a document of interest to the vendor, e.g., document “RW 1114060” which is classified as a family drawing including a large quantity of materials some of which the vendor is approved for and others for which the vendor is not approved. As an aid to the illustrative example of FIG. 12, Table I is provided to describe which materials from the unfiltered drawing list 1200 of FIG. 12, the vendor is approved/not approved for.

TABLE I
Drawing RW1114060

| | Approved/ |
|---|---|
| Material | Not Approved |
| RW1113060 | Not approved |
| RW1114060 | Approved |
| RW1114560 | Approved |
| RW1115060 | Not Approved |
| RW1116060 | Approved |
| RW1117560 | Approved |

At step 715, an SAP software routine filters the unfiltered drawing list as illustrated in FIG. 12 to exclude those drawings which do not include at least one vendor supplied material.

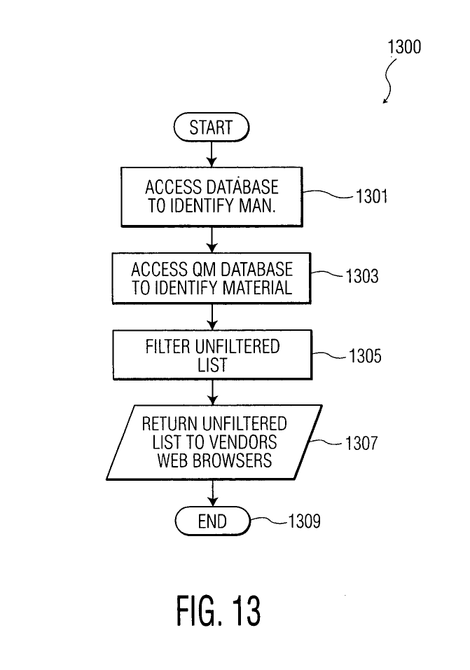

FIG. 13 is a detailed flowchart 1300 of step 715 describing the process for filtering the unfiltered drawing list to exclude those drawings which do not include at least one material associated with the vendor making the query. In the instant example, those non-related vendor drawings include drawings RW1113060 and RW1115060 (see Table I).

At step 1301, the step of filtering the unfiltered drawing list starts with the SAP software routine accessing the VTM database 23 using the vendor's SAP vendor number as an index to determine (look-up) which manufacturers are linked to the vendor making the query.

At step 1303, the manufacturer's identified at step 1301 are then used as an index into the QM database 21 to determine (look-up) the materials that the manufacturer has been approved for. A list of materials is returned by the SAP software routine.

At step 1305, the material list generated at step 1303 is used to filter the unfiltered drawing list to exclude those drawings which do not include at least one vendor approved material identified at step 1303.

At step 1307, the filtered list is returned to the vendor's Web browser.

At step 1309, the SAP routine terminates the filtering process.

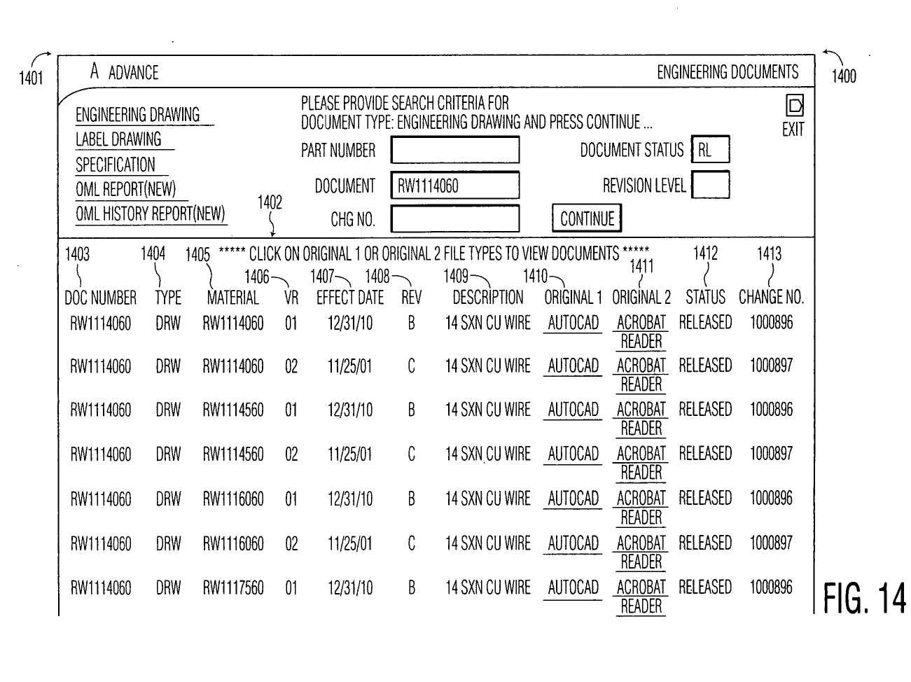

FIG. 14 is a screen view illustrating a Web page 1400 returned to the vendor's Web browser in response to the formulated search query. FIG. 14 illustrates a split-screen mode which allows the vendor to view the vendor supplied search criteria in an upper window 1401 while viewing a corresponding textual representation (referred to as “List View”) of the results of the search in a lower window 1402 (i.e., the “filtered list”). Each line of text displayed in the List View window 1302 refers to a single engineering drawing, and includes various information about the drawing. In one embodiment, each line item includes:

the document (doc) number 1403 (i.e., engineering drawing identifier);

a type indicator 1404 (i.e., DRW=drawing type);

a material identifier 1405;

a year of creation 1406;

the effectivity date indicating the date the drawing becomes effective 1407;

a revision number 1408;

a text description 1409;

original 1 1410;

original 2 1411;

a status indication 1412;

an engineering change order (ECO) number 1413.

A data range is provided as a default value for the “effectivity date”. “original 1” is considered the “master” engineering drawing. “original 2” is a backup mechanism for those vendors who do not possess the appropriate software to view engineering documents in their native language (e.g., Corel, AutoCAD, etc.). Original 2 is the same drawing as original 1 viewable in Acrobat.

B. THE QML REPORT

QML stands for qualified manufacturer's list which comprises all of the components or materials a vendor has been qualified to supply to Advance ^{T}. The list contains data for each material that is vendor specific. The list is compiled from a plurality of tables in the SAP MIS 10. A user can create queries using different parameters to create-variations on the report. Because the data contained in the QML report is also used to determine the drawings that a vendor can view, the user is assured that there are no discrepancies between the two data sources.

The QML report represents a further option for a user when accessing the SAP MIS website 50. The QML report differs from the “Engineering Drawing” link in that in the former there are no links to documents.

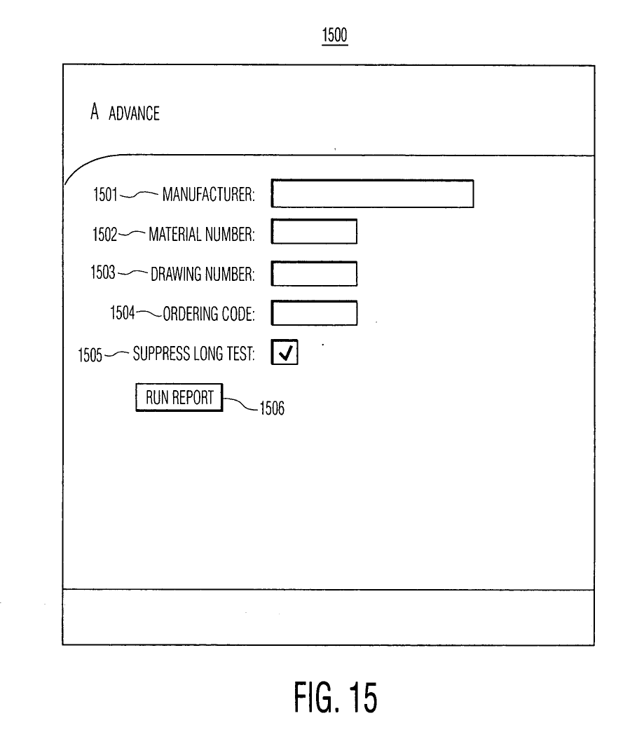

Referring again to FIG. 10, if the vendor selects the “QML Report” hyperlink instead of the “Engineering Drawing” hyperlink as described above, the vendor is shown FIG. 15 which illustrates Web page 1500 which is a text entry screen including a number of text entry boxes 1501 through 1505 for entering search criteria for returning a list of all of the materials the vendor has been qualified to supply to the SAP MIS 10.

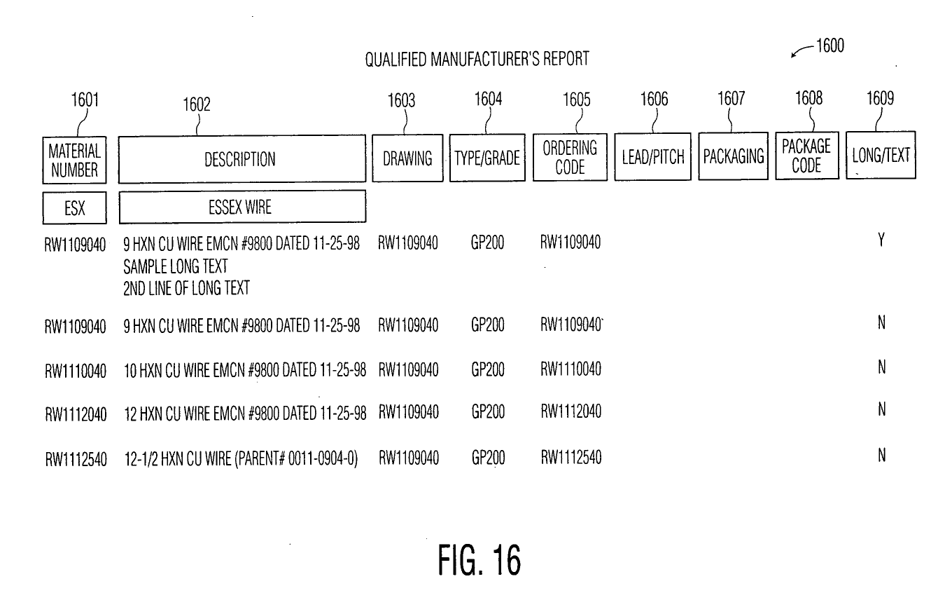

FIG. 16 is a screen view illustrating a Web page 1600 returned to the vendor's Web browser in response to the formulated search query provided at Web page 1500. The materials supplied by the vendor such as material number 1601, description 1602, drawing 1603, type/grade 1604, ordering code 1605, lead/pitch 1606, packaging 1607, package code 1608 and long text 1609.

The data shown in the “QML Report” of FIG. 16 was previously included as part of the engineering drawings. In accordance with the principles of the invention, the data is now removed from the engineering drawings and made part of the QML report to prevent vendors from viewing drawings containing other vendors proprietary data. In this manner, any vendor accessing the SAP website 50 is only afforded an opportunity to view his own proprietary data, either via drawings and/or the QML report.

C. THE QML HISTORY REPORT

The QML report history report represents another option for a user when accessing the SAP MIS website 50. The QML history report, differs from the “Engineering Drawing” link in that in the former there are no links to documents. Typically, an outside supplier (vendor) will receive a phone call from Advance indicating that there is a problem with a material being shipped. Advance may determine that the material is a wrong material for any number of reasons including coding errors when entering the material specifications in the SAP MIS 10 system. In response to being so informed, the vendor has a capability to will access the SAP website 50 to view the detailed history of changes for the material in question to resolve the problem.

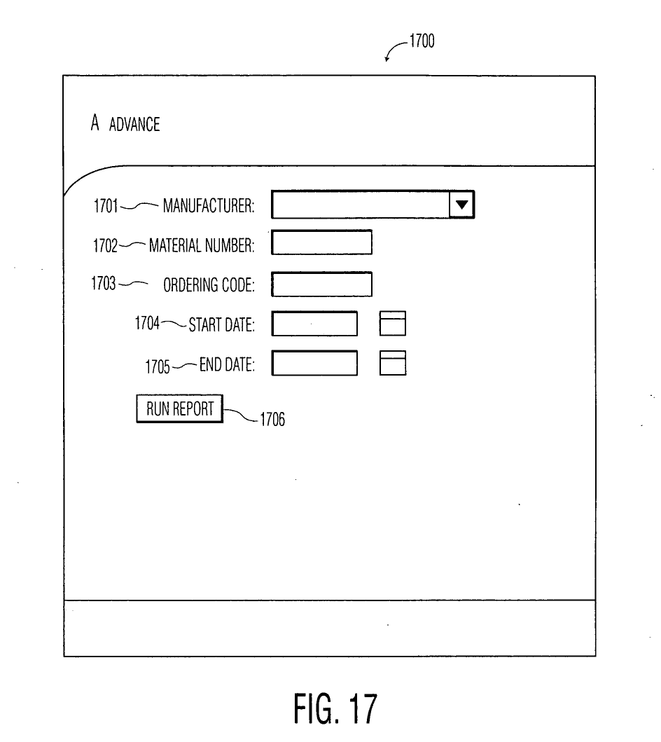

Upon accessing the SAP website 50, Referring again to FIG. 10, if the vendor would select the “QML History Report” hyperlink in this instance. Upon clicking the “QML History Report” hyperlink, the vendor is shown a screen view (see FIG. 17) illustrating Web page 1700 which is a text entry screen including a number of text entry boxes (1701 through 1706) for entering search criteria to inquire about changes which have occurred to a material supplied by an outside vendor. The Web page 1700 includes a first text entry box 1701, which is an optional entry box, for supplying a manufacturer's ID. This is only required in the case where a vendor making the query represents more than one manufacturer and wishes to distinguish between them. The next text entry box identifies the material number 1702 of the material in question. The next text entry box is an ordering code 1703 for the material. It is noted that the vendor may supply the material number 1702 or ordering code 1703, depending on which is more convenient or known at the time of making the query. The start date 1704 and end date 1705 specify a date range for the history report. Any changes which may have occurred between these two specified dates will be included in the report.

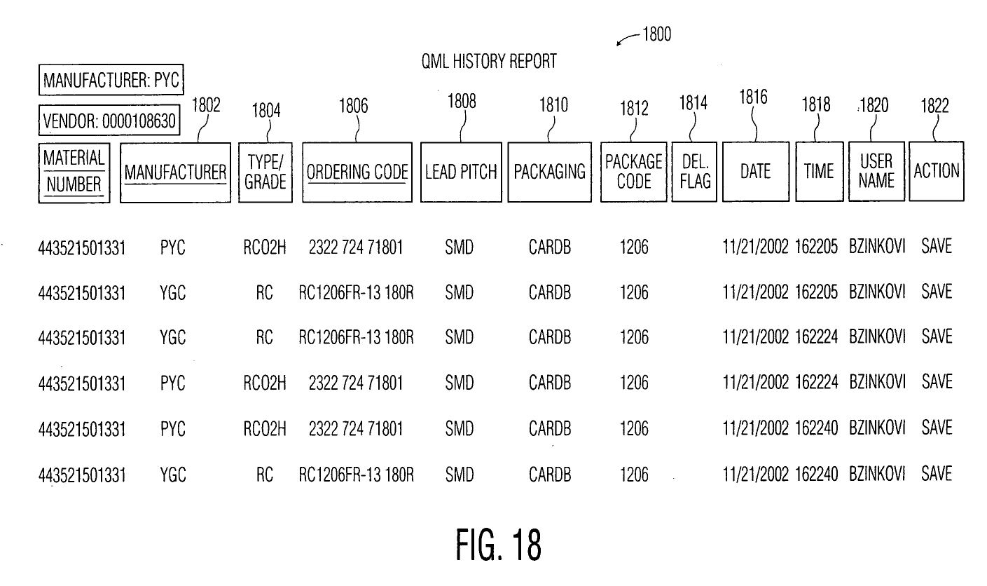

FIG. 18 is a screen view illustrating a Web page 1800 returned to the vendor's Web browser in response to the formulated search query provided at Web page 1700. Each row in the report 1800 refers to a change which has occurred to a material supplied by the vendor making the query. In the instant example, a query was made at Web page 1700 by the vendor for the vendor supplied material number “443521501331”. In response to the query, the QML history report returns six line items in response to the query, as shown at Web page 1800, where each line item indicates a change which has occurred to the material in question over the time interval specified in the query (e.g., start date, end date). Each line item in the report 1800 includes various information about the material change. In the illustrative example shown, each line item includes:

Material number 1800

Manufacturer 1802

Type/Grade 1804

Ordering Code 1806

Lead/Pitch 1808

Packaging 1810

Package code 1812

Del. Flag 1814

Date 1816

Time 1818

User Name 1820

Action 1822.

The interested parties (Advance and the vendor supplying the material) can simultaneously view the QML history report 1800 to see the precise time 1818 and date 1816 of each change as well as other information to resolve any potential problems.

The foregoing is to be constructed as only being an illustrative embodiment of this invention. Persons skilled in the art can easily conceive of alternative arrangements providing a functionality similar to this embodiment without any deviation from the fundamental principles or the scope of this invention.

1. A method of organizing and disseminating data in a management information system (MIS), said method comprising the steps of:
(a) identifying at said MIS at least one outside vendor supplying at least one material included in a notification of drawing change issued from said MIS;
(b) issuing said notification of drawing change from said MIS to said at least one outside vendor identified at said step (a);
(c) accessing an MIS website by said at least one outside vendor responsive to said issued notification;
(d) submitting a database search query by said at least one outside vendor at said MIS website including search criteria for viewing drawings prepared by and stored at said MIS;
(e) retrieving a list of drawings at said MIS satisfying said submitted database search query;
(f) filtering said retrieved list of drawings at said MIS to exclude drawings unrelated to said at least one outside vendor; and
(g) displaying said filtered drawing list to said at least one outside vendor.

2. The method of claim 1, wherein said filtered drawing list only includes drawings comprised of materials which are supplied by said at least one outside vendor.

3. The method of claim 1, wherein said filtered drawing list is comprised of records wherein each record includes at least an engineering drawing document number, a drawing type indicator, a material identifier, a year of drawing creation, an effectivity date, a revision number, a text description, a field for viewing said drawing, a status indication and an engineering change order number.

4. The method of claim 1, wherein said step (a) further comprises the steps of:
determining if said notification of drawing change issued by said MIS system includes a change to at least one engineering drawing stored at said MIS;
further determining if said at least one changed engineering drawing includes a material supplied by said at least one outside vendor, when said determining step is satisfied;
accessing a vendor-to-manufacturer (VTM) database associated with MIS, using said at least one outside vendor supplied material as an index to retrieve a manufacturer of said material, when said further determining step is satisfied; and
(4) accessing a manufacturer-to-vendor (MTV) database associated with MIS using said identified manufacturer at said accessing step as an index to retrieve said at least one outside vendor associated with said manufacturer.

5. The method of claim 1, wherein said step (f) further comprises the steps of:
(1) accessing a vendor-to-manufacturer (VTM) database associated with said MIS using said at least one outside vendor's assigned vendor number as an index to retrieve manufacturers associated with said at least one outside vendor;
(2) accessing a qualified manufacturers (QM) database associated with MIS using said manufacturer identified at said step (1) as an index to retrieve materials for which said manufacturer has been approved for; and
(3) using said retrieved materials to filter said retrieved list of drawings.

6. The method of claim 4, wherein said accessing step further comprises the steps of:
sequentially reviewing each drawing in said retrieved list of drawings to determine if a drawing includes at least one material from among said retrieved materials at said further determining step;
if so, including said reviewed drawing in said filtered drawing list, otherwise excluding said reviewed drawing from said filtered drawing list.

7. The method of claim 1, wherein said notification of drawing change is an engineering change order (ECO) including at least an engineering drawing change number and an effectivity date for determining when said ECO becomes effective.

8. The method of claim 1, wherein said search criteria at said step (d) includes one of a material number, a document number and a notification of drawing change number.

9. The method of claim 1, wherein said step (b) further comprises the step of accessing a block email (BEM) database associated with said MIS to exclude those vendors from among said at least one outside vendor who have been predetermined not to receive said issued notification of drawing change.

10. The method of claim 1, further comprising the step of submitting a database search query by said at least one outside vendor at said MIS website including search criteria for viewing drawing information.

11. The method of claim 10, wherein said search criteria includes a manufacturer identifier, a material number, a drawing number and an ordering code.

12. A system of organizing and disseminating data in a management information system (MIS), said system comprising:
means for identifying at said MIS at least one outside vendor supplying at least one material included in a notification of drawing change issued from said MIS;
means for issuing said notification of drawing change from said MIS to said at least one outside vendor identified at said step (a);
means for accessing an MIS website by said at least one outside vendor responsive to said issued notification;
means for submitting a database search query by said at least one outside vendor at said MIS website including search criteria for viewing drawings prepared by and stored at said MIS;
means for retrieving a list of drawings at said MIS satisfying said submitted database search query;
means for filtering said retrieved list of drawings at said MIS to exclude drawings unrelated to said at least one outside vendor; and
means for displaying said filtered drawing list to said at least one outside vendor.

13. The system of claim 12, wherein said filtered drawing list only includes drawings comprised of materials which are supplied by said at least one outside vendor.

14. The system of claim 12, wherein said filtered drawing list is comprised of records wherein each record includes at least an engineering drawing document number, a drawing type indicator, a material identifier, a year of drawing creation, an effectivity date, a revision number, a text description, a field for viewing said drawing, a status indication and an engineering change order number.

15. The system of claim 12, wherein said means for identifying further comprises:
means for determining if said notification of drawing change issued by said MIS system includes a change to at least one engineering drawing stored at said MIS;
means for further determining if said at least one changed engineering drawing includes a material supplied by said at least one outside vendor when said means for determining is satisfied;
means for accessing a vendor-to-manufacturer (VTM) database associated with MIS, using said at least one outside vendor supplied material as an index to retrieve a manufacturer of said material when said means for further determining is satisfied; and
means for accessing a manufacturer-to-vendor (MTV) database associated with MIS using said identified manufacturer at said step (3) as an index to retrieve said at least one outside vendor associated with said manufacturer.

16. The system of claim 12, wherein said means for filtering further comprises:
means for accessing a vendor-to-manufacturer (VTM) database associated with said MIS using said at least one outside vendor's assigned vendor number as an index to retrieve manufacturers associated with said at least one outside vendor;
means for accessing a qualified manufacturers (QM) database associated with MIS using said identified manufacturer as an index to retrieve materials for which said manufacturer has been approved for; and
means for using said retrieved materials to filter said retrieved list of drawings.

17. The system of claim 16, wherein said means for using further comprises:
means for sequentially reviewing each drawing in said retrieved list of drawings to determine if a drawing includes at least one material from among said retrieved materials;
means for including said reviewed drawing in said filtered drawing list, otherwise excluding said reviewed drawing from said filtered drawing list if it is determined that said drawing includes at least one material from among said retrieved materials.

18. The system of claim 12, wherein said notification of drawing change is an engineering change order (ECO) including at least an engineering drawing change number and an effectivity date for determining when said ECO becomes effective.

19. The method of claim 12, wherein said search criteria includes one of a material number, a document number and a notification of drawing change number.

20. The system of claim 12, wherein said means for issuing said notification of drawing change further comprises:
means for accessing a block email (BEM) database associated with said MIS to exclude those vendors from among said at least one outside vendor who have been predetermined not to receive said issued notification of drawing change.

21. The system of claim 12, further comprising means for submitting a database search query by said at least one outside vendor at said MIS website including search criteria for viewing drawing information.

22. The system of claim 21, wherein said search criteria includes a manufacturer identifier, a material number, a drawing number and an ordering code.
